(19) United States
(12) Patent Application Publication
(10) Pub. No.: US 2017/0328233 A1
(43) Pub. Date: Nov. 16, 2017

(54) VALVE DEVICE AND STEAM TURBINE

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Yoshitaka HAMAMOTO, Tokyo (JP); Hideki TONAKA, Tokyo (JP); Makoto KATAGAKE, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/533,231

(22) PCT Filed: Sep. 30, 2015
(86) PCT No.: PCT/JP2015/077801

§ 371 Date: Jun. 5, 2017

(30) Foreign Application Priority Data
Dec. 8, 2014 (JP) 2014-248012

(51) Int. Cl. F01D 17/10; F16K 1/30; F16K 31/04; F16K 31/44

(52) U.S. Cl. CPC F01D 17/10; F16K 31/44; F16K 1/308; F16K 31/04

(57) ABSTRACT

A valve device includes: an opening and closing section capable of being switched between an open state and a closed state, and a drive section having a rectilinearly moving mechanism configured to move a rectilinearly movable member in forward and backward directions; a transmission section configured to bring the opening and closing section to the closed state when the rectilinearly movable member is moved forward and to bring the opening and closing section to the open state when the rectilinearly movable member is moved backward; and a switching section capable of being switched between a connected state in which the movement of the rectilinearly movable member in the forward and backward directions is able to be transmitted to the transmission section and a disconnected state in which the movement of the rectilinearly movable member in the forward and backward directions is unable to be transmitted to the transmission section.

### TECHNICAL FIELD

The present invention relates to a valve device and a steam turbine. Priority is claimed on Japanese Patent Application No. 2014-248012, filed Dec. 8, 2014, the content of which is incorporated herein by reference.

### BACKGROUND ART

Steam turbines include turbine main bodies having rotors used for the purpose of machine driving or the like which are rotatably supported. Rotors are rotatably driven when steam serving as an operating fluid is supplied to turbine main bodies. Steam supplied to turbine main bodies or steam extracted from turbine main bodies flows through steam passages of steam turbines. Regulating valves are provided in steam passages. Flow rates of steam supplied to turbine main bodies can be adjusted by adjusting degrees of opening of regulating valves.

Regulating valves are driven by adjusting valve drive devices. Examples of adjusting valve drive devices include a structure including an electric motor serving as a driving source, a ball screw configured to convert a rotational motion of an electric motor into a rectilinear motion of a regulating valve, and the like.

Such a rectilinearly moving mechanism is disclosed in, for example, Patent Literature 1. In the rectilinearly moving mechanism disclosed in Patent Literature 1, a one-way mechanism is provided on an output shaft of a motor on an upstream side of a rotation/linear motion converting mechanism.

### CITATION LIST

### Patent Literature

### [Patent Literature 1]

Japanese Unexamined Patent Application, First Publication No. 2010-112409

### SUMMARY OF INVENTION

### Technical Problem

However, in a regulating valve drive mechanism using the above-described rectilinearly moving mechanism, when the rectilinearly moving mechanism is damaged at the time of normal operation and a stroke operation of moving in forward and backward directions is locked, it is difficult to adjust a degree of opening of a regulating valve. For this reason, when supply of steam to a steam turbine needs to be stopped by cutting off supply using the regulating valve, there is a possibility that the supply of the steam can not be stopped even if a steam passage is closed.

The present invention provides a valve device and a steam turbine which can close a passage regardless of a state of a rectilinearly moving mechanism.

### Solution to Problem

In order to accomplish the above-described objective, the present invention provides the following means.

A valve device in a first aspect of the present invention opens and closes a passage through which an operating fluid flows to adjust a flow rate of the operating fluid, the valve device including: an opening and closing section capable of being switched between an open state in which the operating fluid is able to flow through the passage and a closed state in which the operating fluid is unable to flow through the passage; a drive section having a rectilinearly moving mechanism configured to convert rotation of a motor into a rectilinear motion and to move a rectilinearly movable member in forward and backward directions; a transmission section configured to move the opening and closing section in a closing direction in which the opening and closing section is brought to the closed state when the rectilinearly movable member is moved forward and to move the opening and closing section in an opening direction in which the opening and closing section is brought to the open state when the rectilinearly movable member is moved backward; and a switching section capable of being switched between a connected state in which movement of the rectilinearly movable member in forward and the backward directions is able to be transmitted to the transmission section and a disconnected state in which movement of the rectilinearly movable member in the forward and the backward directions is unable to be transmitted to the transmission section.

According to such a constitution, a connected state is set using the switching section so that switching between an open state and a closed state of the opening and closing section can be driven via the transmission section using the rectilinearly movable member. A disconnected state is set using the switching section so that movement of the rectilinearly movable member is not transmitted to the transmission section and thus the opening and closing section can be driven independently of the rectilinearly moving mechanism and brought to a closed state regardless of the rectilinearly moving mechanism. Thus, a regulating valve can be reliably driven regardless of the rectilinearly moving mechanism and thus the passage can be stably closed in an emergency.

In the valve device in a second aspect of the present invention, in the first aspect, the switching section may have: a connection member connected to the transmission section; and a detachable section being brought to the connected state by fixing the connection member to the rectilinearly movable member and being brought to the disconnected state by separating the rectilinearly movable member and the connection member from each other.

According to such a constitution, the rectilinearly movable member, a portion with respect to the connection member of which is fixed, is separated using the detachable section so that movement of the rectilinearly movable member in the forward and backward directions cannot be transmitted to the transmission section and thus a disconnected state can be easily set.

In the valve device in a third aspect of the present invention, in the second aspect, the switching section may have an auxiliary connection section configured to couple the rectilinearly movable member and the connection member such that it is able to be moved in forward and backward directions when the rectilinearly movable member and the connection member are separated from each other.

According to such a constitution, the rectilinearly movable member and the connection member are coupled via the auxiliary connection section even in a disconnected state. As a result, the auxiliary connection section can prevent the connection member from being fully separated from the rectilinearly movable member. For this reason, when the valve device returns to a connected state in an emergency, a connection member can be easily guided and connected to the rectilinearly movable member again using the auxiliary connection section as a guide. Thus, a connected state of the valve device can be easily restored after a disconnected state.

In the valve device in a fourth aspect of the present invention, in the first aspect, the switching section may have: a funicular member connected to the rectilinearly movable member; and a funicular member drive section connected to the transmission section and configured to wind and feed the funicular member, wherein the funicular member drive section may set the connected state by regulating an amount of feeding of the funicular member and set the disconnected state by releasing the regulation of the amount of feeding of the funicular member.

According to such a constitution, the rectilinearly movable member and a transmission section are coupled through the funicular member and the funicular member drive section even in a disconnected state. For this reason, when the valve device returns to a connected state in an emergency, an amount of feeding of the funicular member is adjusted by winding the funicular member again through the funicular member drive section so that the rectilinearly movable member and the transmission section can be easily connected again. Thus, the valve device can be easily restored from a disconnected state to a connected state.

A steam turbine in a fifth aspect of the present invention includes: the valve device according to any one of the first to fourth aspects; a steam passage configured to be opened and closed using the valve device; and a turbine main body driven using steam supplied from the steam passage.

According to such a constitution, reliability of the steam turbine can be improved.

### Advantageous Effects of Invention

According to the present invention, a connected state and a disconnected state can be switched between using a switching section so that a passage can be closed regardless of a state of a rectilinearly moving mechanism.

### BRIEF DESCRIPTION OF DRAWINGS

FIG. 1 is a schematic diagram showing an overall configuration of a steam turbine in an embodiment of the present invention.

FIG. 2 is a schematic diagram showing a valve device in a connected state in a first embodiment of the present invention.

FIG. 3 is a cross-sectional view showing an internal configuration of an electric actuator in an embodiment of the present invention, FIG. 3(a) is a diagram showing a state before a nut moves along an axis, and FIG. 3(b) is a diagram showing a state after the nut moves along the axis.

FIG. 4 is a schematic diagram showing a switching section in a first embodiment of the present invention, FIG. 4(a) is a cross-sectional view of a switching section in a connected state, and FIG. 4(b) is a cross-sectional view of a switching section in a disconnected state.

FIG. 5 is a schematic diagram showing a detachable section of a switching section in the first embodiment of the present invention.

FIG. 6 is a schematic diagram showing a valve device in a disconnected state in the first embodiment of the present invention.

FIG. 7 is a schematic diagram showing a switching section in a disconnected state in a second embodiment of the present invention.

FIG. 8 is a schematic diagram showing an adjusting valve drive device in a connected state in a third embodiment of the present invention.

FIG. 9 is a schematic diagram showing the adjusting valve drive device in a disconnected state in the third embodiment of the present invention.

FIG. 10 is a schematic diagram illustrating a first modification of a detachable section of the present invention.

FIG. 11 is a schematic diagram illustrating a second modification of a detachable section of the present invention.

### DESCRIPTION OF EMBODIMENTS

### First Embodiment

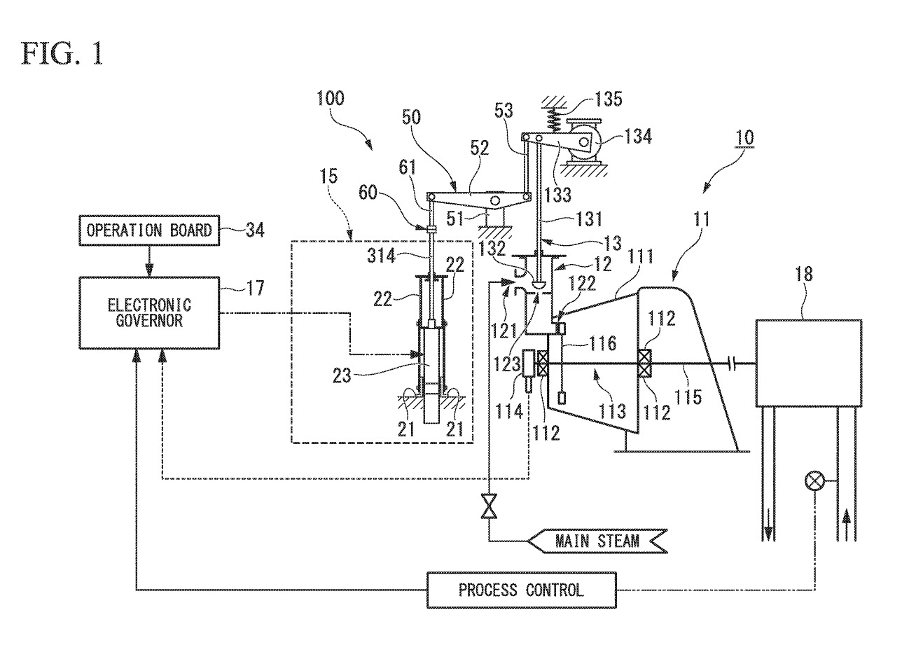

Hereinafter, a first embodiment according to the present invention will be described with reference to FIGS. 1 to 6.

As shown in FIG. 1, a steam turbine 10 of the embodiment includes a turbine main body 11, a steam passage 12 through which steam as an operating fluid flows, a valve device 100, and an electronic governor 17 configured to control the valve device 100.

The turbine main body 11 includes a tubular casing 111, a bearing 112 provided in the casing 111, a rotor 113 rotatably supported by the bearing 112 and arranged inside the casing 111, and a speed-detecting sensor 114 configured to detect a rotational speed of the rotor 113. The rotor 113 includes a rotating shaft 115 and a plurality of blades 116 fixed to the rotating shaft 115.

The blades 116 constituted in this way are rotated due to steam and a compressor 18 is driven due to the rotating force.

The steam passage 12 is a passage configured to supply steam as an operating fluid to the turbine main body 11. Here, in the description of the embodiment, as “the steam passage 12” associated with the invention, the passage through which the steam supplied to the turbine main body 11 flows will be exemplified. However, the steam passage 12 is not limited thereto and may be, for example, a passage through which steam is extracted from the turbine main body 11.

In the case of the steam passage 12 in the embodiment, steam is introduced through a steam-introducing port 121 on a first end side of the steam passage 12. A steam supply port 122 of the steam passage 12 on a second end side thereof is connected to the turbine main body 11. A throttle hole 123 with a slightly narrowed passage width is provided between the steam-introducing port 121 and the steam supply port 122.

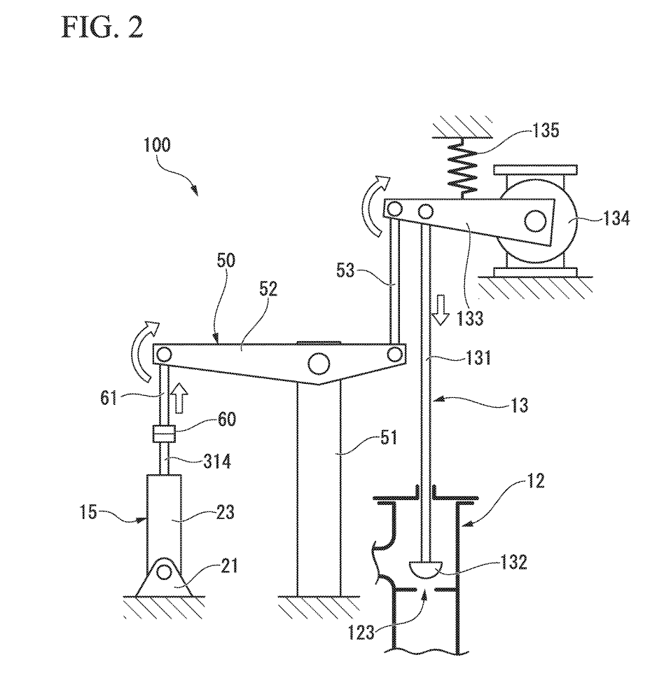

The valve device 100 opens and closes the steam passage 12 through which steam flows to adjust a flow rate of steam in the turbine main body 11. As shown in FIG. 2, the valve device 100 includes a regulating valve (an opening and closing section) 13, an adjusting valve drive device (a drive section) 15, a transmission section 50, and a switching section 60. The regulating valve (the opening and closing section) 13 moves a valve body and adjusts a steam quantity supplied to the turbine main body 11. The adjusting valve drive device (the drive section) 15 drives the regulating valve 13. The transmission section 50 transmits an output of the adjusting valve drive device 15 to the regulating valve 13. The switching section 60 switches between transmission states with respect to the transmission section 50.

The regulating valve 13 adjusts a steam quantity supplied to the turbine main body 11. The regulating valve 13 is switched between an open state in which steam can flow through the steam passage 12 and a closed state in which steam cannot flow through the steam passage 12. The regulating valve 13 in the embodiment has a cylindrical arm member 131, a sealing member 132, a lever member 133, a support section 134, and a spring section 135. The sealing member 132 is provided on a distal end serving as a first end of the arm member 131. The lever member 133 is connected to a proximal end serving as a second end opposite to the sealing member 132 of the arm member 131. The support section 134 rotatably supports the lever member 133. The spring section 135 is attached to the lever member 133.

A proximal end of the arm member 131 is rotatably attached to a portion of the lever member 133 which is closer to a distal end side than an intermediate portion in a longitudinal direction thereof.

The sealing member 132 has a shape which can close the throttle hole 123. The sealing member 132 in the embodiment has a substantially semicircular shape. In the sealing member 132, the arm member 131 is rectilinearly moved with respect to the throttle hole 123 along the steam passage 12. The sealing member 132 brings the steam passage 12 to a closed state when the sealing member 132 is engaged with the throttle hole 123 of the steam passage 12. The sealing member 132 brings the steam passage 12 to an open state when the sealing member 132 moves away from the throttle hole 123. In other words, in the regulating valve 13, the sealing member 132 is rectilinearly moved between an opening direction in which the steam passage 12 is brought to an open state and a closing direction in which the steam passage 12 is brought to a closed state.

The support section 134 is fixed to a horizontal surface of a frame (not shown) or the like of the steam passage 12 and thus cannot be moved.

The lever member 133 is a member in which the arm member 131 is moved so that the sealing member 132 is moved with respect to the throttle hole 123 of the steam passage 12 in forward and backward directions thereof. The lever member 133 has a bar shape. A proximal end of the lever member 133 serving as first end in a longitudinal direction thereof is rotatably supported by the support section 134. As described above, the proximal end of the arm member 131 is rotatably attached to an intermediate portion of the lever member 133 in the longitudinal direction thereof.

The spring section 135 is attached to the lever member 133 between the arm member 131 and the support section 134. The spring section 135 functions as a forcibly closing means for forcibly closing the regulating valve 13. An end of the spring section 135 on a side which is not connected to the lever member 133 is fixed and the spring section 135 cannot be moved. The spring section 135 biases the lever member 133 such that the sealing member 132 is directed toward the throttle hole 123. In other words, the spring section 135 biases the lever member 133 in a direction in which the lever member 133 is rotated counterclockwise in FIG. 1 about the support section 134 in a state in which an external force is not applied.

The adjusting valve drive device 15 drives the regulating valve 13 used to open and close the throttle hole 123 of the steam passage 12 through which steam flows using the sealing member 132 to adjust a flow rate of the steam. As shown in FIG. 1, the adjusting valve drive device 15 includes a pair of brackets 21, a holding member 22, and an electric actuator 23. The pair of brackets 21 are fixedly installed. The holding member 22 is rotatably supported by the brackets 21. The electric actuator 23 is supported by the brackets 21 and the holding member 22 and drives the regulating valve 13.

The pair of brackets 21 have a substantially L-shaped cross section. The pair of brackets 21 are fixed above a base (not shown).

The holding member 22 holds the electric actuator 23 therein. The holding member 22 is rotatably supported by the pair of brackets 21.

The electric actuator 23 includes a rectilinearly moving mechanism 27 and a brake 28.

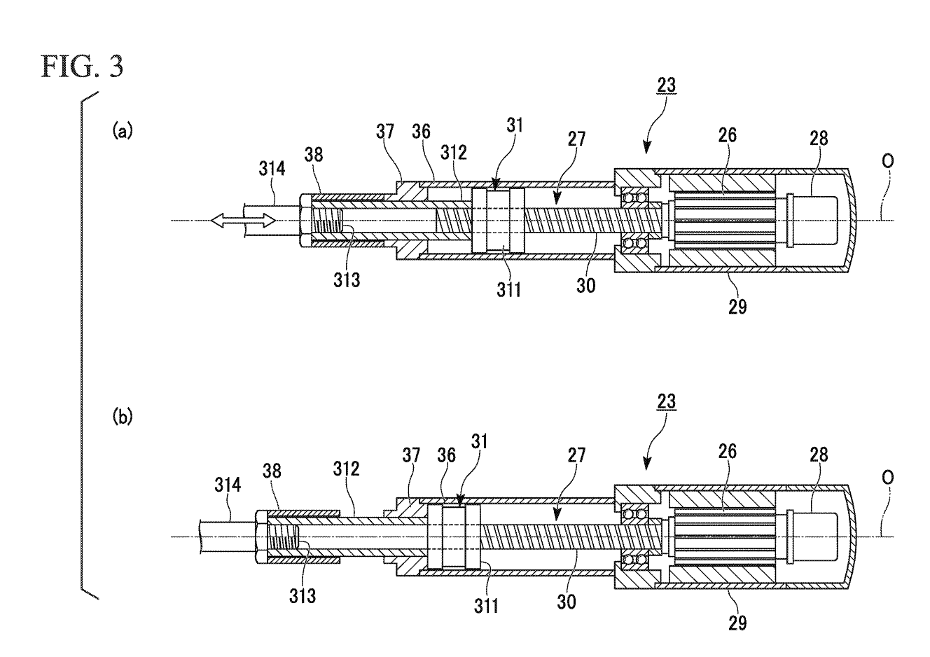

The rectilinearly moving mechanism 27 is a mechanism for converting a rotational motion of an electric motor 26 into a rectilinear motion and moving a rectilinearly movable rod (a rectilinearly movable member) 314 in forward and backward directions thereof. The rectilinearly moving mechanism 27 in the embodiment is a ball screw mechanism. To be specific, as shown in FIG. 3, the rectilinearly moving mechanism 27 in the embodiment has the electric motor 26, a screw shaft 30, a piston unit 31, and a piston casing 36. The electric motor 26 is a driving source. The screw shaft 30 is connected to a driving shaft of the electric motor 26 and rotatably driven about an axis O through the electric motor 26. The piston unit 31 relatively moves in forward and backward directions thereof along which the axis O of the screw shaft 30 extends (right and left directions on the paper in FIG. 3) along with rotation of the screw shaft 30. The piston casing 36 covers the piston unit 31 from the outside.

The electric motor 26 is a driving source configured to receive supply of power and to rotate a driving shaft. The electric motor 26 is accommodated in a motor housing 29. The motor housing 29 is provided on a proximal end of the electric actuator 23 and has a sealed inside. Thus, the electric motor 26 has an explosion-proof structure isolated from oil in the vicinity thereof.

The screw shaft 30 is a long screw member. A screw groove of the screw shaft 30 is formed in an outer circumferential surface thereof. A First end side of the screw shaft 30 in forward and backward directions thereof (a left side on the page in FIG. 3) is connected to the driving shaft of the electric motor 26.

The piston unit 31 reciprocates along the screw shaft 30. As shown in FIG. 3, the piston unit 31 in the embodiment has a nut 311, a cylinder rod 312, a rod end connector 313, and the rectilinearly movable rod 314. The screw shaft 30 is inserted through an inside of the nut 311 to be screwed therein. The screw shaft 30 is inserted through the cylinder rod 312. The rod end connector 313 is provided on a first end side of the cylinder rod 312 in forward and backward directions thereof. The rectilinearly movable rod 314 is connected to the cylinder rod 312 via the rod end connector 313.

The cylinder rod 312 is formed in a tubular shape in which an outer side of the screw shaft 30 is covered such that the screw shaft 30 can be inserted through an inside thereof. A proximal end of the cylinder rod 312 is fixed to a surface of first end of the nut 311 in forward and backward directions thereof through fixtures such as bolts.

The rod end connector 313 is a member mounted on a distal end of the cylinder rod 312. A female screw is formed in an inner circumferential surface of the rod end connector 313 on a distal end side thereof.

The rectilinearly movable rod 314 is moved in the forward and backward directions thereof with respect to the screw shaft 30 in accordance with movement of the nut 311. The rectilinearly movable rod 314 is a cylindrical member extending in the forward and backward directions thereof such that the cylinder rod 312 extends. The rectilinearly movable rod 314 has a male screw formed in a first end thereof. A male screw of the rectilinearly movable rod 314 is screwed and fixed to a female screw of the rod end connector 313. A distal end serving as a second end of the rectilinearly movable rod 314 is connected to the transmission section 50 via the switching section 60.

The piston casing 36 covers the screw shaft 30 and the nut 311 from the outer side in a radial direction of the screw shaft 30. An outer circumferential surface of the nut 311 comes in sliding contact with an inner circumferential surface of the piston casing 36. The piston casing 36 has a piston cap 37 configured to seal a first end side thereof in forward and backward directions thereof. An opening through which the cylinder rod 312 is inserted is formed in the piston cap 37. At this time, an end of the cylinder rod 312 on a first end side in the forward and backward directions is exposed from the piston casing 36 to the outside at all times. The piston cap 37 regulates movement of the nut 311 in the forward and backward directions thereof.

The brake 28 is disposed at a portion which is opposite to the screw shaft 30 to sandwich the electric motor 26. The brake 28 has an electromagnetic disk brake. The brake 28 operates when supply of power is cut off and brakes rotation of the electric motor 26. An operation of the brake 28 is controlled by the electronic governor 17 (refer to FIG. 1). When a circumferential speed of the screw shaft 30 is more than a threshold value, the electronic governor 17 operates the brake 28. In other words, the electronic governor 17 brakes the rotation of the electric motor 26 by operating the brake 28.

The transmission section 50 is moved in a closing direction in which the regulating valve 13 is brought to a closed state when the rectilinearly movable rod 314 is moved forward. The transmission section 50 is moved in an opening direction in which the regulating valve 13 is brought to an open state when the rectilinearly movable rod 314 is moved backward. The transmission section 50 in the embodiment reduces an amount of movement of the rectilinearly moving mechanism 27 transmitted via the rectilinearly movable rod 314 and transmits the reduced amount of movement to the lever member 133. The transmission section 50 has a support shaft 51, a transmission member 52 rotatably supported by the support shaft 51, and a transmission rod 53 configured to connect the lever member 133 and the transmission member 52.

The support shaft 51 has a bar shape. A proximal end side serving as a first end of the support shaft 51 is fixed to a horizontal plane of a frame or the like of the steam passage 12 and the support shaft 51 cannot be moved. The transmission member 52 is rotatably supported by a distal end side serving as a second end of the support shaft 51.

The transmission member 52 has a bar shape, a diameter of which reduces toward both ends thereof. A first end of the transmission member 52 is connected to the transmission rod 53. A second end of the transmission member 52 is connected to the rectilinearly movable rod 314 via the switching section 60. The transmission member 52 is supported by the support shaft 51 on a side closer to the transmission rod 53 than an intermediate portion.

The transmission rod 53 transmits an output of the transmission member 52 to the lever member 133 and rotates the lever member 133. The transmission rod 53 has a cylindrical shape. A First end of the transmission rod 53 is rotatably connected to the first end of the transmission member 52. A second end of the transmission rod 53 is rotatably to a distal end of the lever member 133. An end of the transmission rod 53 on a side which is connected to the transmission rod 53 of the transmission member 52 is vertically moved so that a distal end of the lever member 133 is vertically moved.

The switching section 60 is switched between a connected state in which movement of the rectilinearly movable rod 314 in the forward and backward directions can be transmitted to the transmission member 52 and a disconnected state in which movement of the rectilinearly movable rod 314 in the forward and backward directions cannot be transmitted to the transmission member 52. The switching section 60 in the embodiment has a connection rod (a connection member) 61 and a detachable section 62. The connection rod (the connection member) 61 is connected to the transmission member 52. The detachable section 62 enables the connection rod 61 to be attached to or detached from the rectilinearly movable rod 314.

The connection rod 61 transmits an amount of movement of the rectilinearly movable rod 314 in the rectilinearly moving mechanism 27 to the transmission member 52. The connection rod 61 has a cylindrical shape. A First end of the connection rod 61 is rotatably connected to the transmission rod 53 of the transmission member 52. A second end of the connection rod 61 is connected to the rectilinearly movable rod 314 via the detachable section 62.

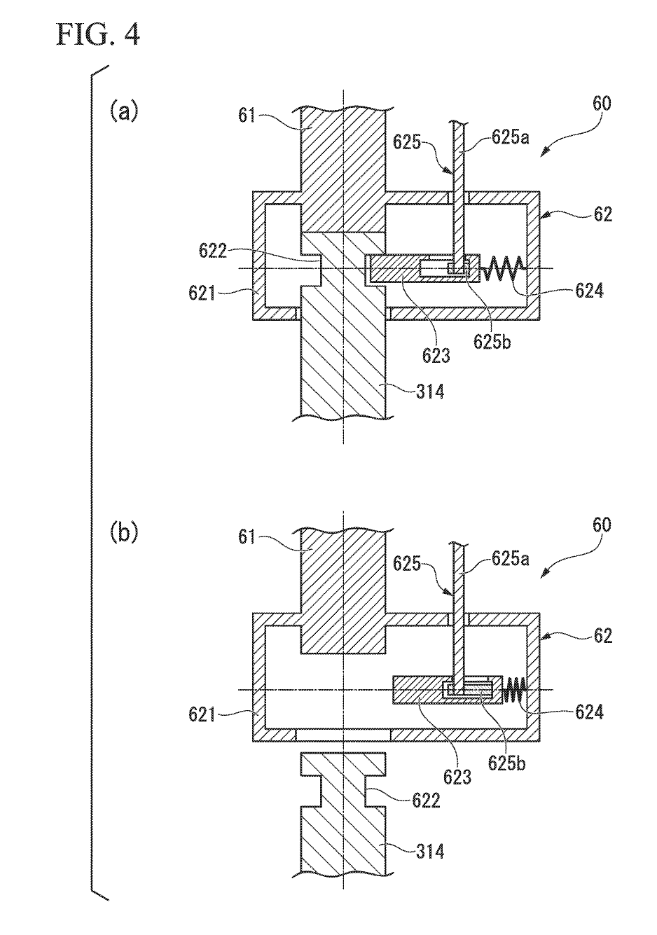

The detachable section 62 is brought to a connected state by fixing the position of the connection rod 61 with respect to the rectilinearly movable rod 314. The detachable section 62 is brought to a disconnected state by separating the rectilinearly movable rod 314 and the connection rod 61 from each other. The detachable section 62 in this embodiment is provided on a distal end of the connection rod 61 at a side which is not connected to the transmission member 52. As shown in FIG. 4(a), the detachable section 62 has a detachable casing 621, a key groove 622, a key plate 623, a detachable biasing section 624, and a key operation unit 625. The detachable casing 621 is integrally provided with the distal end of the connection rod 61. The key groove 622 is provided on the distal end of the rectilinearly movable rod 314. The key plate 623 is provided inside the detachable casing 621. The detachable biasing section 624 biases the key plate 623 toward the key groove 622. The key operation unit 625 manipulates a position of the key plate 623.

The detachable casing 621 is integrally formed with the connection rod 61 on the distal end of the connection rod 61. The detachable casing 621 in this embodiment has a hollow rectangular shape. A through-hole through which the rectilinearly movable rod 314 is inserted and a through-hole through which the key operation unit 625 (which will be described below) is inserted are formed in the detachable casing 621.

The key groove 622 is formed in the rectilinearly movable rod 314 in a shape in which the key plate 623 can be inserted when an end surface of the distal end of the rectilinearly movable rod 314 comes into contact with an end surface of the distal end of the connection rod 61. The key groove 622 in this embodiment is recessed in a rectangular shape over the entire circumference from an outer circumferential surface of the rectilinearly movable rod 314.

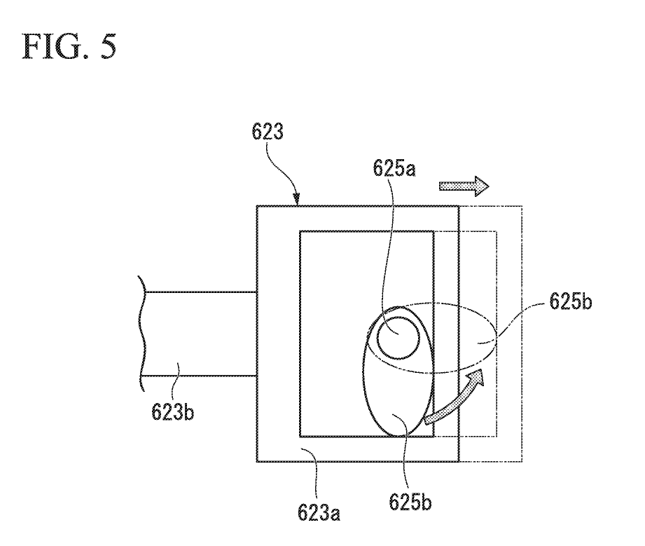

The key plate 623 is fitted into the key groove 622 so that the rectilinearly movable rod 314 is not separated from the connection rod 61. As shown in FIG. 5, the key plate 623 in this embodiment has a key plate main body 623a and a key plate insertion section 623b. The key plate main body 623a accommodates the key operation unit 625 therein. The key plate insertion section 623b is inserted into the key groove 622.

The key plate main body 623a is formed in a rectangular ring shape. The key plate main body 623a accommodates the key operation unit 625 in an internal space thereof.

The key plate insertion section 623b is integrally formed with the key plate main body 623a and has a rectangular plate shape extending toward the key groove 622.

The detachable biasing section 624 is attached to the key plate 623 inside the detachable casing 621. The detachable biasing section 624 is constituted of an elastic member such as a spring member. An end of the detachable biasing section 624 on a side which is not connected to the key plate 623 is fixed to an inner wall of the detachable casing 621 and thus cannot be moved. In other words, the detachable biasing section 624 biases the key plate 623 toward a left side on the paper in FIG. 4(a) in a state in which an external force is not applied. In other words, the detachable biasing section 624 biases the key plate 623 fitted into the key groove 622 to prevent the key plate 623 from being released from the key groove 622.

The key operation unit 625 can manipulate the position of the key plate 623 from the outside. The key operation unit 625 in this embodiment has a key operation shaft 625a connected to the outside and a cam section 625b attached to a distal end of the key operation shaft 625a.

The key operation shaft 625a has a bar shape. An end of the key operation shaft 625a on a side opposite to the distal end thereof attached to the cam section 625b can be manipulated from the outside.

The cam section 625b is integrally attached to a distal end of the key operation unit 625. The cam section 625b has an elliptical shape.

The electronic governor 17 controls an operation of the adjusting valve drive device 15.

As shown in FIG. 1, a result of process control on the basis of a detection result of a pressure and a temperature in the compressor 18 is input to the electronic governor 17. A rotational speed of the blades 116 detected by the speed-detecting sensor 114 constituting the turbine main body 11 is input to the electronic governor 17. An instruction of a user input through an operation board 34 is input to the electronic governor 17. The electronic governor 17 controls an operation of the adjusting valve drive device 15 on the basis of the inputs. To be more specific, the electronic governor 17 controls an operation of the electric motor 26 constituting the electric actuator 23 on the basis of the inputs.

In the steam turbine 10 as described above, the electronic governor 17 transmits signals to the electric actuator 23 so that the driving shaft of the electric motor 26 rotates. The driving shaft of the electric motor 26 rotates in a forward direction so that the screw shaft 30 rotates. As a result, the nut 311 is moved from a position shown in FIG. 3(a) toward a position shown in FIG. 3(b). Thus, the cylinder rod 312, the rod end connector 313, and the rectilinearly movable rod 314 fixed to the nut 311 are also moved forward along the screw shaft 30 together with the nut 311. The rectilinearly movable rod 314 is moved forward and moved upward so that the connection rod 61 connected via the detachable section 62 is also moved. To be specific, the connection rod 61 is moved upward together with the rectilinearly movable rod 314 so that the transmission member 52 is rotated in a clockwise direction as shown in FIG. 2 about a portion thereof connected to the support shaft 51. The transmission member 52 is rotated clockwise so that an end of the transmission member 52 on a side connected to the transmission rod 53 is moved downward together with the transmission rod 53. The transmission rod 53 is moved downward so that the lever member 133 is rotated about the support section 134 counterclockwise. Therefore, the arm member 131 is moved down and thus the sealing member 132 is moved in a closing direction toward the throttle hole 123. Thus, in the regulating valve 13, an opening between the throttle hole 123 and the sealing member 132 is changed to become smaller. For this reason, a flow rate of steam supplied to the turbine main body 11 via the throttle hole 123 decreases.

In contrast, the driving shaft of the electric motor 26 is rotated in a reverse direction so that the screw shaft 30 is rotated in reverse. As a result, the nut 311 is moved from the position in FIG. 3(b) toward the position shown in FIG. 3(a). Thus the rectilinearly movable rod 314 or the like is moved backward along the screw shaft 30 together with the nut 311. The rectilinearly movable rod 314 is moved backward and moved downward so that the connection rod 61 connected via the detachable section 62 is also moved. To be specific, the connection rod 61 is moved downward together with the rectilinearly movable rod 314. Thus, the transmission member 52 is rotated about a portion thereof connected to the support shaft 51 in a counterclockwise direction as shown in FIG. 2. The transmission member 52 is rotated counterclockwise so that an end thereof on a side connected to the transmission rod 53 is moved upward together with the transmission rod 53. The transmission rod 53 is moved upward so that the lever member 133 is rotated about the support section 134 clockwise. Therefore, the arm member 131 is moved up and thus the sealing member 132 is moved toward the throttle hole 123 in an opening direction. Thus, in the regulating valve 13, an opening between the throttle hole 123 and the sealing member 132 is changed to become larger. Thus, a flow rate of steam supplied to the turbine main body 11 via the throttle hole 123 increases.

The valve device 100 repeatedly performs the above-described movements in a minute range so that a normal operation of the steam turbine 10 is performed while a flow rate of steam is adjusted finely.

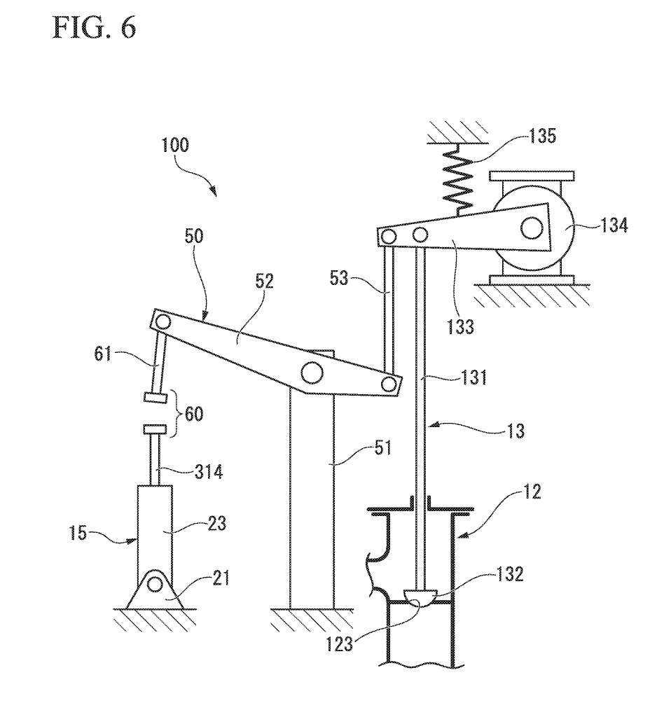

Damage or anchorage may occur in the rectilinearly moving mechanism 27, the rectilinearly movable rod 314 may not be able to be moved, and thus the regulating valve 13 is brought to a closed state in some cases. In this case, as shown in FIG. 5, the cam section 625b is rotated by operating the key operation shaft 625a of the key operation unit 625. The cam section 625b is rotated so that the key plate main body 623a is pressed by the cam section 625b against a biasing force of the detachable biasing section 624 and the key plate insertion section 623b is released from the key groove 622 as shown in FIG. 4(b). The key plate insertion section 623b is released from the key groove 622 so that the rectilinearly movable rod 314 fixed to the connection rod 61 and having a connected state is separated from the connection rod 61 and has a disconnected state. As shown in FIG. 6, the rectilinearly movable rod 314 and the connection rod 61 are separated from each other so that the regulating valve 13 can be independently driven.

According to the steam turbine 10 including the valve device 100 and the valve device 100 as described above, the connection rod 61 connected to the transmission member 52 is coupled to the rectilinearly movable rod 314 through the detachable section 62 and thus the connection rod 61 and the rectilinearly movable rod 314 are brought to a connected state. Thus, the regulating valve 13 can be driven so that the regulating valve 13 is switched between an open state and a closed state via the transmission member 52 using the rectilinearly moving mechanism 27. The connection rod 61 and the rectilinearly movable rod 314 are separated from each other through the detachable section 62 and thus the connection rod 61 and the rectilinearly movable rod 314 are brought to a disconnected state so that the connection rod 61 does not move even when the rectilinearly movable rod 314 is moved. For this reason, movement of the rectilinearly moving mechanism 27 is not transmitted to the transmission member 52. As a result, the lever member 133 is biased by a biasing force of the spring section 135 so that the arm member 131 is moved down and the throttle hole 123 can be closed by the sealing member 132. For example, an emergency such as a case in which, although damage or anchorage occurs in the rectilinearly moving mechanism 27 and the rectilinearly movable rod 314 cannot be moved, the regulating valve 13 needs to be cut off may occur in some cases. In such an emergency, a disconnected state is set so that the regulating valve 13 is driven independently of the rectilinearly moving mechanism 27 regardless of a state of the rectilinearly moving mechanism 27 and thus the regulating valve 13 can be brought to a closed state. Thus, the regulating valve 13 can be reliably driven regardless of the rectilinearly moving mechanism 27 and thus the steam passage 12 can be stably closed in an emergency. As a result, reliability of the steam turbine 10 can be improved.

The transmission member 52 moves the lever member 133 via the transmission rod 53 such that the rectilinearly movable rod 314 is moved forward so that the regulating valve 13 is brought to a closed state. For this reason, when the rectilinearly movable rod 314 is separated from the connection rod 61 by the detachable section 62 and the rectilinearly movable rod 314 and the connection rod 61 are brought to a disconnected state, the connection rod 61 or the transmission member 52 is moved so as to be separated from the rectilinearly movable rod 314 so that the regulating valve 13 can be brought to a closed state. Therefore, a disconnected state can be easily set regardless of a position of the rectilinearly movable rod 314.

The rectilinearly movable rod 314, a portion with respect to the connection rod 61 of which is fixed is separated by the detachable section 62 so that movement of the rectilinearly movable rod 314 in the forward and backward directions cannot be transmitted to the transmission rod 53 and thus a disconnected state can be easily set.

### Second Embodiment

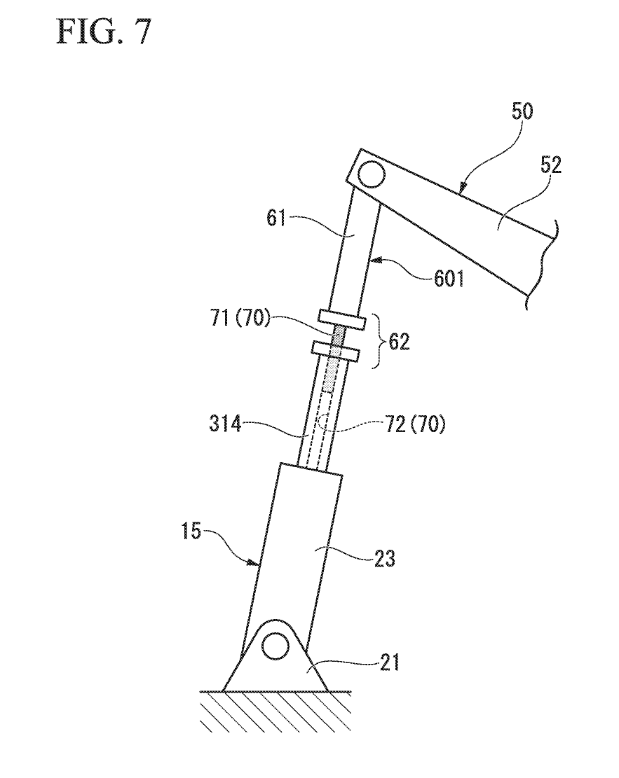

Next, a switching section 601 of a second embodiment will be described with reference to FIG. 7.

In the second embodiment, constituent elements which are the same as those of the first embodiment are denoted with the same reference numerals and the detailed descriptions thereof will be omitted. The switching section 601 of the second embodiment is different from that of the first embodiment in that the switching section 601 of the second embodiment has an auxiliary connection section 70 configured to couple a rectilinearly movable rod 314 and a connection rod 61.

The switching section 601 of the second embodiment has the auxiliary connection section 70. When the rectilinearly movable rod 314 and the connection rod 61 are separated from each other through a detachable section 62, the auxiliary connection section 70 couples the rectilinearly movable rod 314 and the connection rod 61 to be able to be moved in forward and backward directions of the rectilinearly movable rod 314.

The auxiliary connection section 70 couples the connection rod 61 to the rectilinearly movable rod 314 even when the rectilinearly movable rod 314 and the connection rod 61 are separated from each other until a regulating valve 13 is brought to a closed state. The auxiliary connection section 70 in this embodiment has a guide rod 71 and a guide hole 72 as shown in FIG. 7. The guide rod 71 is attached to the connection rod 61. The guide hole 72 is formed in the rectilinearly movable rod 314 and has the guide rod 71 inserted therethrough.

The guide rod 71 has a cylindrical shape with a cross-sectional shape which is smaller than that of the connection rod 61. The guide rod 71 is attached to a distal end of the connection rod 61 in a direction in which the connection rod 61 extends. The guide rod 71 is disposed in a state in which the guide rod 71 is inserted through the guide hole 72. The guide rod 71 is formed to have a length in which the guide rod 71 is not released from the guide hole 72 even when the rectilinearly movable rod 314 and the connection rod 61 are separated from each other until the regulating valve 13 is brought to a closed state.

The guide hole 72 has a circular cross-sectional shape through which the guide rod 71 can be inserted and is formed in the rectilinearly movable rod 314. The guide hole 72 is recessed from a distal end of the rectilinearly movable rod 314.

According to a valve device 100 of the second embodiment as described above, the rectilinearly movable rod 314 and the connection rod 61 are separated from each other through the detachable section 62 and the rectilinearly movable rod 314 and the connection rod 61 are brought to a disconnected state so that the connection rod 61 is independently moved with respect to the rectilinearly movable rod 314 and is separated. At this time, the guide rod 71 is inserted into the guide hole 72. For this reason, the connection rod 61 is moved with respect to the rectilinearly movable rod 314 so as to pull the guide rod 71 accommodated in the guide hole 72. In other words, the connection rod 61 moves so as to withdraw the guide rod 71 from the guide hole 72, and is separated from the rectilinearly movable rod 314 until the regulating valve 13 is brought to a closed state. Therefore, the guide rod 71 is inserted through the guide hole 72 even when the rectilinearly movable rod 314 and the connection rod 61 are brought to a disconnected state so that the rectilinearly movable rod 314 and the connection rod 61 are coupled to each other via the guide rod 71. As a result, the connection rod 61 can be prevented from being fully separated from the rectilinearly movable rod 314. For this reason, when the valve device 100 returns to a connected state after the regulating valve 13 is brought to a closed state in an emergency, the connection rod 61 can be easily guided and connected to the rectilinearly movable rod 314 again using the guide rod 71 and the guide hole 72 as a guide. Thus, the valve device 100 can be easily restored from a disconnected state to a connected state.

### Third Embodiment

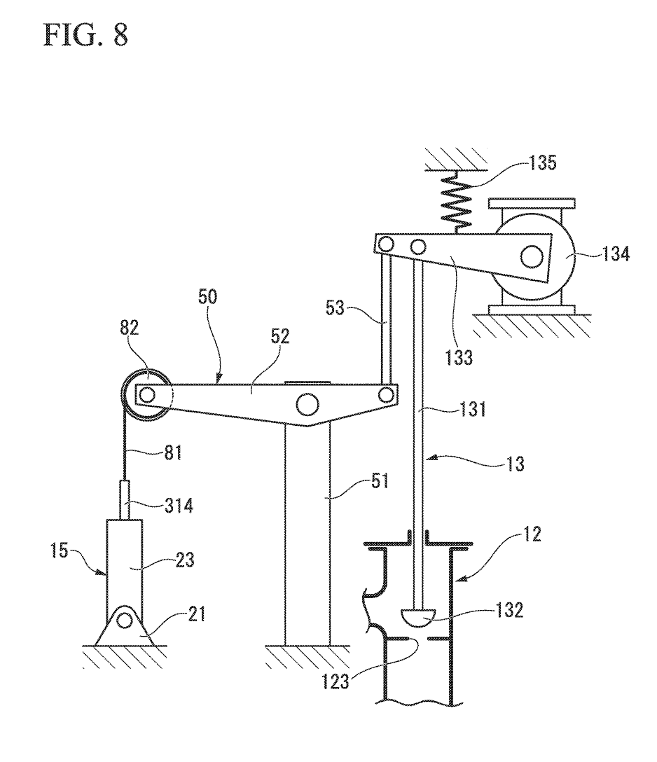

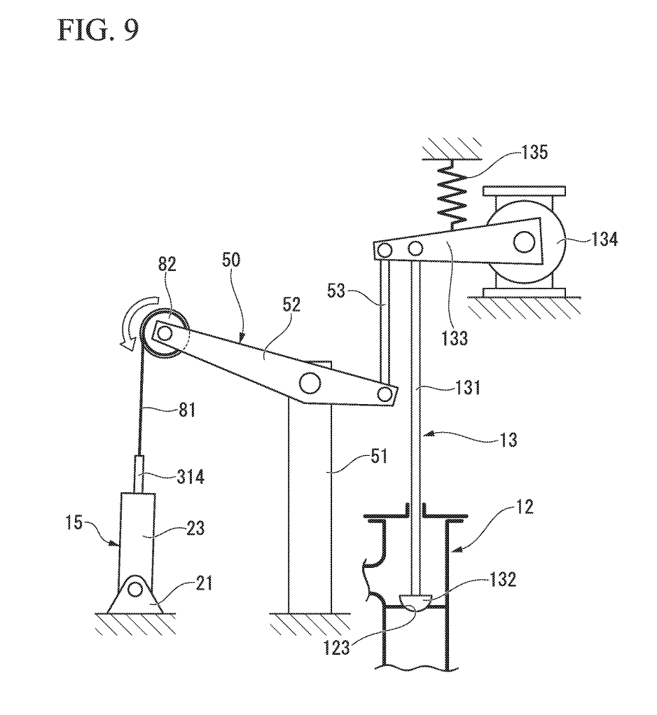

Next, a switching section 602 of a third embodiment will be described with reference to FIGS. 8 and 9.

In the third embodiment, constituent elements which are the same as those of the first embodiment and the second embodiment are denoted with the same reference numerals and the detailed descriptions thereof will be omitted. The switching section 602 in the third embodiment is different from those of the first embodiment and the second embodiment in that a funicular member is used without using a connection rod 61.

The switching section 602 in the third embodiment is switched between a connected state and a disconnected state while connecting a rectilinearly movable rod 314 and a transmission member 52. The switching section 602 has a wire (a funicular member) 81 and a pulley section (a funicular member drive section) 82 as shown in FIG. 8. The wire (the funicular member) 81 is connected to the rectilinearly movable rod 314. The pulley section (the funicular member drive section) 82 is connected to a transmission rod 53.

A First end of the wire 81 is connected to a distal end of the rectilinearly movable rod 314. A second end of the wire 81 is fixed to the pulley section 82 and the wire 81 is wound around the pulley section 82 and accommodated.

The pulley section 82 is rotatably connected to an end of the transmission member 52 on a side which is not connected to the transmission rod 53. The wire 81 can be wound around and fed from the pulley section 82. The pulley section 82 regulates an amount of feeding of the wire 81 to set a connected state. The pulley section 82 releases the regulation of the amount of feeding of the wire 81 to set a disconnected state. To be specific, the pulley section 82 in this embodiment has a one-way mechanism such as a ratchet therein. The pulley section 82 cannot feed the wire 81 using the one-way mechanism in a connected state. The pulley section 82 can freely feed the wire 81 by releasing the one-way mechanism.

According to a valve device 100 of the third embodiment as described above, as shown in FIG. 8, the pulley section 82 prevents feeding of the wire 81 using the one-way mechanism and thus a connected state is set. Thus, movement of the rectilinearly movable rod 314 in forward and backward directions can be transmitted to the transmission member 52 through the already fed wire 81 connected to the rectilinearly movable rod 314. For this reason, a regulating valve 13 can be driven via the transmission member 52 using a rectilinearly moving mechanism 27 to be switched between an open state and a closed state thereof.

As shown in FIG. 9, the pulley section 82 releases the one-way mechanism so that the wire 81 is freely fed and thus a disconnected state is set. Thus, the wire 81 is slackened or the pulley section 82 is rotated even when the rectilinearly movable rod 314 is moved in forward and backward directions so that movement of the rectilinearly movable rod 314 in the forward and backward directions cannot be transmitted to the transmission member 52. For this reason, the regulating valve 13 can be driven independently of the rectilinearly moving mechanism 27. For example, an emergency such as a case in which, although damage or anchorage occurs in the rectilinearly moving mechanism 27 and the rectilinearly movable rod 314 cannot be moved, the regulating valve 13 needs to be cut off occurs in some cases. In such an emergency, a disconnected state is set so that a lever member 133 is biased by a biasing force using a spring section 135 regardless of a state of the rectilinearly moving mechanism 27, the arm member 131 is moved down, and thus a throttle hole 123 can be closed by a sealing member 132. Thus, the regulating valve 13 can be reliably driven regardless of the rectilinearly moving mechanism 27 and thus a steam passage 12 can be stably closed in an emergency. As a result, reliability of a steam turbine 10 can be improved.

Even in a disconnected state, the rectilinearly movable rod 314 and the transmission member 52 are coupled to each other through the wire 81 and the pulley section 82. For this reason, when the regulating valve 13 is brought to a closed state in an emergency and then returns to a connected state, the wire 81 is wound again using the one-way mechanism of the pulley section 82 so that the rectilinearly movable rod 314 and the transmission member 52 can be easily connected again. Thus, the valve device 100 can be easily restored from a disconnected state to a connected state.

Although the embodiments of the present invention have been described in detail above with reference to the drawings, the constitutions and the combinations thereof in the embodiments are merely examples. In addition, additions, omissions, substitutions, and other changes to the configuration can be made without departing from the gist of the present invention. Furthermore, the present invention is not limited to the embodiments and is limited only by the appended claims.

Note that the structure of the detachable section 62 of the first embodiment and the second embodiment is not limited to the structure illustrated in the first embodiment.

The detachable section 62 may have a shape in which the position of the connection rod 61 can be fixed to the rectilinearly movable rod 314 or the position of the connection rod 61 can be separated from the rectilinearly movable rod 314.

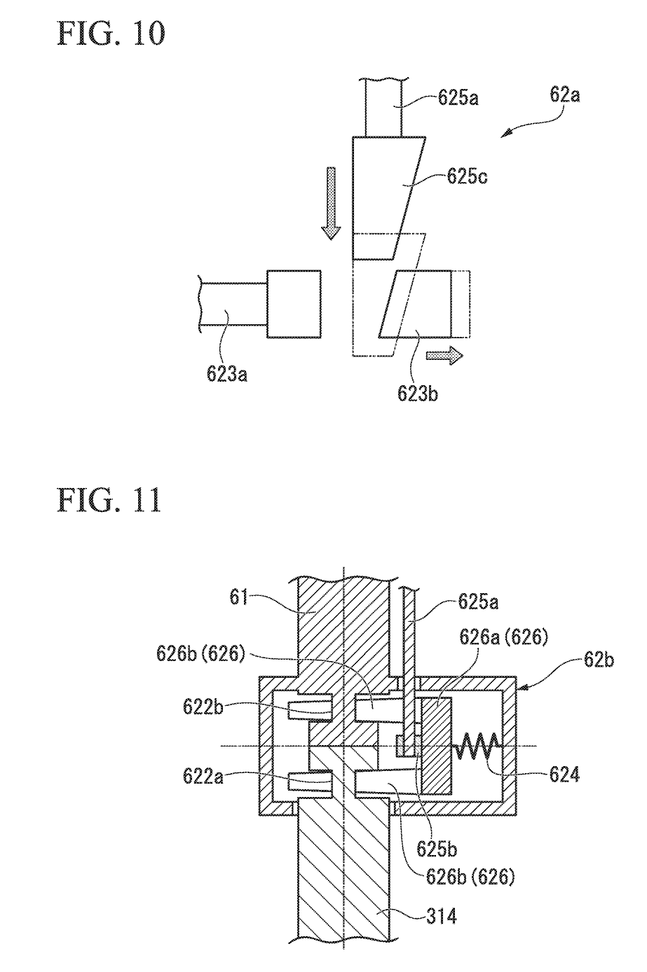

For example, as shown in FIG. 10, in a detachable section 62a in a first variation, a key operation unit 625 may have a wedge 625c, a cross section of which has a wedge shape instead of a cam section 625b. In the detachable section 62a in the first variation, the key operation unit 625 having the wedge 625c is inserted toward a key plate 623 so that the wedge 625c is inserted into an internal space of a key plate main body 623a. Therefore, an inner circumferential surface of the key plate main body 623a is pressed by the wedge 625c, the key plate 623 is moved, and thus the key plate insertion section 623b can be released from a key groove 622.

For example, as shown in FIG. 11, a detachable section 62b in the second variation may have a structure in which a key groove 622 is formed in both a connection rod 61 and a rectilinearly movable rod 314. The detachable section 62b in the second variation includes a rectilinearly movable rod side key groove 622a, a connection rod side key groove 622b, and deformed key plates 626. The rectilinearly movable rod side key groove 622a is provided on a distal end of the rectilinearly movable rod 314. The connection rod side key groove 622b is provided on a distal end of the connection rod 61. The deformed key plates 626 are fitted into the rectilinearly movable rod side key groove 622a and the connection rod side key groove 622b. A detachable section 62 has a detachable casing 621, a detachable biasing section 624, and a key operation unit 625 as in the first embodiment.

The rectilinearly movable rod side key groove 622a is formed in the same shape as the key groove 622 in the first embodiment.

The connection rod side key groove 622b is recessed in a rectangular shape over the entire circumference from an outer circumferential surface of the connection rod 61.

The deformed key plates 626 are fitted into the rectilinearly movable rod side key groove 622a and the connection rod side key groove 622b and sandwich the rectilinearly movable rod 314 and the connection rod 61 so that the rectilinearly movable rod 314 and the connection rod 61 are not separated from each other. The deformed key plates 626 have deformed key plate main bodies 626a and deformed key plate insertion sections 626b. The deformed key plate main bodies 626a come into contact with the cam section 625b of the key operation unit 625. The deformed key plate insertion sections 626b are inserted into the rectilinearly movable rod side key groove 622a and the connection rod side key groove 622b.

The deformed key plate main bodies 626a have a rectangular plate shape.

The deformed key plate insertion sections 626b extend in a prismatic shape from four corners of the deformed key plate main bodies 626a toward the key groove 622.

Also in the detachable section 62 of the second variation as described above, the connection rod 61 can be easily fixed to the rectilinearly movable rod 314 or the connection rod 61 can be easily separated from the rectilinearly movable rod 314 as in the first embodiment.

A funicular member is not limited to a wire 81. A funicular member may be a chain or a string-shaped member. A funicular member drive section is not limited to a pulley section 82 with a one-way mechanism. A funicular member drive section may be a gear, a pulley, or the like which can control rotation.

### INDUSTRIAL APPLICABILITY

According to the above-described valve device, a connected state and a disconnected state can be switched between through a switching section so that a passage can be closed regardless of a state of a rectilinearly moving mechanism.

### REFERENCE SIGNS LIST

10 Steam turbine

11 Turbine main body

111 Casing

112 Bearing

113 Rotor

114 Speed-detecting sensor

115 Rotating shaft

116 Blade

12 Steam passage

121 Steam-introducing port

122 Steam supply port

123 Throttle hole

100 Valve device

13 Regulating valve (opening and closing section)

131 Arm member

132 Sealing member

133 Lever member

134 Support section

135 Spring section

15 Adjusting valve drive device (drive section)

21 Bracket

22 Holding member

23 Electric actuator

26 Electric motor

27 Rectilinearly moving mechanism

28 Brake

29 Motor housing

30 Screw shaft

31 Piston unit

311 Nut

312 Cylinder rod

313 Rod end connector

314 Rectilinearly movable rod (rectilinearly movable member)

36 Piston casing

37 Piston cap

50 Transmission section

51 Support shaft

52 Transmission member

53 Transmission rod

60, 601, 602 Switching section

61 Connection rod (connection member)

62, 62a, 62b Detachable section

621 Detachable casing

622 Key groove

623 Key plate

623a Key plate main body

623b Key plate insertion section

624 Detachable biasing section

625 Key operation unit

625a Key operation shaft

625b Cam section

17 Electronic governor

18 Compressor

70 Auxiliary connection section

71 Guide rod

72 Guide hole

81 Wire

82 Pulley section

625c Wedge

622a Rectilinearly movable rod side key groove

622b Connection rod side key groove

626 Deformed key plate

626a Deformed key plate main body

626b Deformed key plate insertion section

1. A valve device which opens and closes a passage through which an operating fluid flows to adjust a flow rate of the operating fluid, the valve device comprising:
an opening and closing section capable of being switched between an open state in which the operating fluid is able to flow through the passage and a closed state in which the operating fluid is unable to flow through the passage;
a drive section having a rectilinearly moving mechanism configured to convert rotation of a motor into a rectilinear motion and to move a rectilinearly movable member in forward and backward directions;
a transmission section configured to move the opening and closing section in a closing direction in which the opening and closing section is brought to the closed state when the rectilinearly movable member is moved forward and to move the opening and closing section in an opening direction in which the opening and closing section is brought to the open state when the rectilinearly movable member is moved backward; and
a switching section capable of being switched between a connected state in which movement of the rectilinearly movable member in forward and the backward directions is able to be transmitted to the transmission section and a disconnected state in which movement of the rectilinearly movable member in the forward and the backward directions is unable to be transmitted to the transmission section.

2. The valve device according to claim 1, wherein the switching section has:
a connection member connected to the transmission section; and
a detachable section being brought to the connected state by fixing the connection member to the rectilinearly movable member and being brought to the disconnected state by separating the rectilinearly movable member and the connection member from each other.

3. The valve device according to claim 2, wherein the switching section has an auxiliary connection section configured to couple the rectilinearly movable member and the connection member to be able to be moved in forward and backward directions when the rectilinearly movable member and the connection member are separated from each other.

4. The valve device according to claim 1, wherein the switching section has:
a funicular member connected to the rectilinearly movable member; and
a funicular member drive section connected to the transmission section and configured to wind and feed the funicular member,
wherein the funicular member drive section sets the connected state by regulating an amount of feeding of the funicular member and sets the disconnected state by releasing the regulation of the amount of feeding of the funicular member.

5. A steam turbine, comprising:
the valve device according to claim 1;
a steam passage configured to be opened and closed using the valve device; and
a turbine main body driven through steam supplied from the steam passage.

6. A steam turbine, comprising:
the valve device according to claim 2;
a steam passage configured to be opened and closed using the valve device; and
a turbine main body driven through steam supplied from the steam passage.

7. A steam turbine, comprising:
the valve device according to claim 3;
a steam passage configured to be opened and closed using the valve device; and
a turbine main body driven through steam supplied from the steam passage.

8. A steam turbine, comprising:
the valve device according to claim 4;
a steam passage configured to be opened and closed using the valve device; and
a turbine main body driven through steam supplied from the steam passage.
